(19) United States
(12) Patent Application Publication
(10) Pub. No.: US 2016/0309961 A1
(43) Pub. Date: Oct. 27, 2016

(54) PARCHMENT FORMS FOR COOKING FOOD IN AN ACCELERATED COOKING OVEN AND METHOD

(71) Applicant: West Carrollton Parchment & Converting, Inc., West Carrollton City, OH (US)

(72) Inventor: CAMERON LONERGAN, West Carrollton, OH (US)

(21) Appl. No.: 15/088,209

(22) Filed: Apr. 1, 2016

Related U.S. Application Data
(60) Provisional application No. 62/150,357, filed on Apr. 21, 2015.

(51) Int. Cl. A47J 43/20

(52) U.S. Cl. CPC A47J 43/20; A23L 1/0128; A23V 2002/00

(57) ABSTRACT

Food can be cooked in an accelerated cooking oven by placing the food on a heat-resistant container and, in particular, a container formed from vegetable parchment filled with an inert inorganic filler such as titanium dioxide. The parchment paper can be coated on one side with a silicone release coating. This container is suitable for use in an accelerated cooking oven to prevent messes from forming in the oven without significant discoloration, burning or flaking.

### RELATED APPLICATION

The present application claims priority to U.S. Ser. No. 62/150,357 filed Apr. 21, 2015, the disclosure of which is hereby incorporated herein by reference in its entirety.

### BACKGROUND OF THE INVENTION

Accelerated cooking ovens use a combination of impinged air and microwaves to very quickly cook or heat food items. These ovens are particularly useful for cooking or heating individual, smaller food items such as sandwiches. Generally, these ovens heat items from room temperature to the desired eating temperature in one minute or less.

Any time one cooks something in an oven, splattering can occur and other messes can be created which require constant cleaning of the oven. To avoid this, small food items can be placed on a liner so as to prevent a mess from forming on the internal surface of the oven. Flowable products must be held in a container while being heated. Due to the high temperatures of these accelerated cooking ovens, normal liner material cannot be used. Thermoplastic liners would typically melt. Foil cannot be used because of the microwave portion of the oven. Typical paper products tend to char and fragment.

Thicker reusable materials, such as silicone rubber, glass or ceramic, could be employed, but these may slow down or impede the cooking and, further, they would require cleaning.

### SUMMARY OF THE INVENTION

The present invention is premised on the realization that food items can be cooked in an accelerated cooking oven by placing the food item on a parchment material, in particular, a vegetable parchment filled with an inert inorganic filler which enables the parchment to resist the conditions of an accelerated cooking oven.

More particularly, the present invention provides a method of cooking food wherein the food rests in the oven in a formed parchment container which comprises vegetable parchment having an inorganic filler in an amount effective to provide adequate heat resistance for the vegetable parchment in the accelerated cooking oven.

The vegetable parchment, preferably coated on one side with a non-stick surface, can be thermoformed into a container with a base and sidewall(s). For example, the container can be a cup or a tray. These can be used to cook a single item in an accelerated cooking oven or multiple items simultaneously.

The objects and advantages of the present invention will be further appreciated in light of the following detailed description and drawing in which:

### BRIEF DESCRIPTION OF THE DRAWINGS

FIG. 1 is a perspective view of a parchment cup according to the present invention;

FIG. 1A is a cross-sectional view taken at lines 1A-1A of FIG. 1; and

FIG. 2 is a perspective view of a parchment cup with an integral rim.

### DETAILED DESCRIPTION

According to the present invention, a cooking container 12, which can be used in an accelerated cooking oven, is formed from a parchment sheet 14 which includes one surface coated with a silicone release coating 16 or other non-stick surface.

For use in the present invention, the parchment 14 is a vegetable parchment which is a paper formed by subjecting cellulosic fibers to sulfuric acid, forming an amyloid film on the exterior of the fibers. When the acid is washed off, the amyloid film hardens on the fibers and in the interstices of the paper. This increases the strength of the paper and enables it to be contacted with water without disintegration. Basically any vegetable parchment can be used in the present invention. These are formed with various types of cellulosic fibers, such as hardwood fibers and softwood fibers, as well as cotton fibers and the like.

The weight of the parchment can vary widely. Generally, the parchment will have a weight of about 27 to 100 pounds per 3000 square feet or more, more typically 45 to 65 pounds, generally 47 pounds per 3,000 square foot ream. This higher weight facilitates thermoforming. However, lower weight parchment can also be used. The thickness of the parchment can also vary widely, generally from about 0.002″ to about 0.003″. If creped, which may be desired in some applications, the thickness of the paper will increase to 0.009″ to 0.013″. Vegetable parchment is available from a variety of different sources.

The parchment of the present invention will further include an amount of a non-toxic inert, inorganic filler which can withstand the sulfuric acid reaction conditions in an amount effective to prevent the parchment from charring and, in particular, for 2 minutes at 500° F. as described in the example below. Suitable fillers include metal oxides such as titanium oxide, zinc oxide, as well as others, as long as they can withstand the sulfuric acid treatment conditions.

The filler increases temperature resistance of the parchment required in the present invention. Generally, this can be from 10 to 40 kg per metric tonne (1000 kg of fiber). Generally this will be 30 to 40 kg with a loading of 40 kg, providing the maximum heat resistance.

The moisture content of the parchment is generally 5-7%, generally 5.5-6.5% and in particular 6.3% by weight.

The parchment paper can be smooth parchment paper or it can be creped if desired. Creping creates an undulating surface 18 which may improve heat flow and airflow around the item being cooked. Creping from 5 to 12%, and in particular about 9.5%, improves the browning of products using the sheet of the present invention. For cooking liquid products such as eggs, creping is unnecessary.

Preferably, the inner side of the container 12 may be coated with a release coating 16. The thickness of the coating should range from 0.1 to 0.3 lbs/3000 ft² ream on a dry basis. Silicone release coatings are commercially available and any food grade silicone coating which will adhere to the parchment can be used in the present invention. Generally, if the parchment is creped, the coatings 16 are generally applied prior to the creping.

The container 12 of the present invention includes a base 18 surrounded by a sidewall 20. The container 12 can be any desired shape, such as round, rectangular, oval or the like. The shape and size are primarily determined by the intended end use.

Likewise, the height of the sidewalls is also determined by intended end use. The volume of the container must be sufficient to hold any liquid within it during cooking, considering expansion and the like.

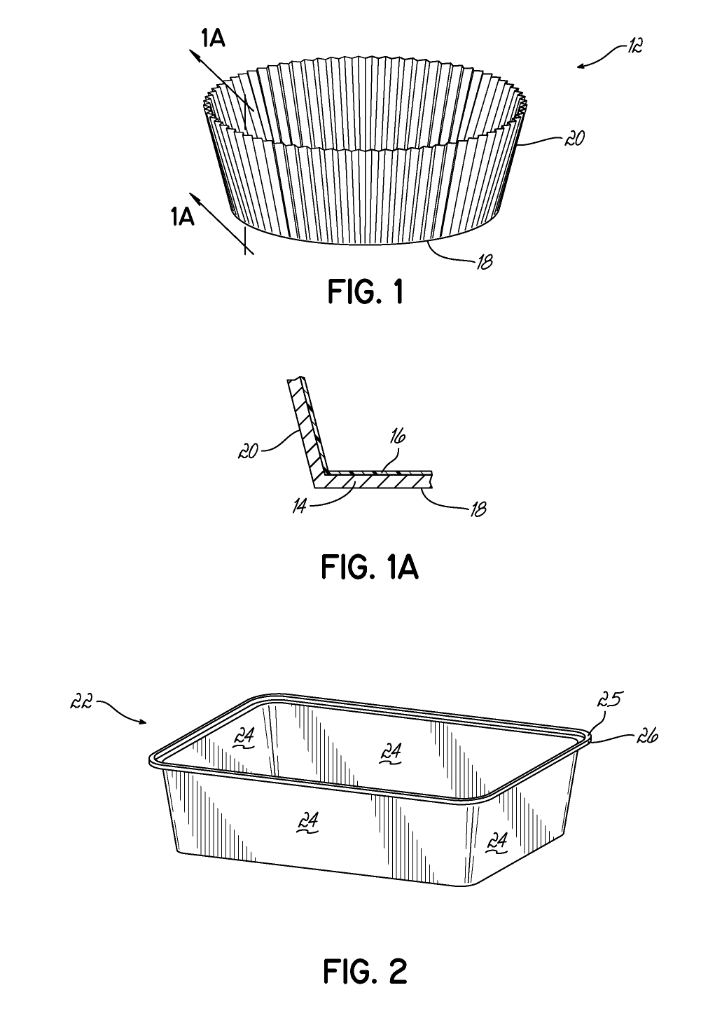

FIGS. 1 and 2 show two different embodiments of the present invention. FIG. 1 shows a round cup 12 with a fluted sidewall 20. FIG. 2 shows a rectangular container 22 with press-formed sidewalls 24 and further includes a ledge 25 and a rim 26, which provides added strength and allows a plastic cover (not shown) to snap fit over the container 22.

The containers shown in FIGS. 1 and 2 are formed by thermoforming a parchment sheet. An apparatus suitable for forming the container shown in FIG. 2 is disclosed in U.S. published application US2014/0374472. Basically, the containers are formed solely of the vegetable parchment as previously described without any added structure or support. The parchment is formed solely from the material added in the furnish and the optional silicone coating on the inside surface of the containers.

The dimensions of containers 12 or 22 can vary widely. The end use and processing limitations dictate the maximum dimensions. The sidewalls will generally be 1″ to 3″ high. The base may have a diameter (or length for a non-round container) of up to 2.9 inches. The rimmed containers 22 as shown in FIG. 2 can be larger because of the added strength provided by the rim.

The containers of the present invention can be used to cook or heat a wide variety of different products, including liquids such as eggs and the like. The food material which is to be cooked is simply placed in the container, which is then placed in accelerated cooking oven and heated at a temperature generally about 520° F., more likely 400-500° F., for a period of two minutes or less, generally one minute or less and generally at least about 10 seconds. The container does not discolor or char and does not alter the taste of the food. Exemplary items that can be heated or cooked using the containers of the present invention include eggs, biscuits from a dough or reheated, muffins from batter or reheated, sautéing vegetables, quiches, cheese sticks, sausages and other meat products as well as many other food products.

This has been a description the present invention, along with the preferred method of practicing the present invention, however, the invention itself should only be defined by the appended claims, wherein we claim:

What is claimed is:

1. A method of cooking food comprising positioning said food on a container, wherein:
said container is formed from a vegetable parchment sheet having an inert inorganic filler in an amount effective to provide heat resistance to the sheet at a temperature of 500° F. for two minutes;
heating said food in said container in an accelerated cooking oven, wherein said container is contacted with flowing hot air for a time effective to heat the food to a desired temperature.

2. The method claimed in claim 1 wherein said container has a first silicone release layer on an inner surface of said container.

3. The method claimed in claim 1 wherein said inert inorganic filler is titanium dioxide.

4. The method claimed in claim 5 wherein said effective amount is from about 10 to about 40 kg per metric tonne of filler.

5. A container effective to support food products while being cooked in an accelerated heat oven, said container comprising a base and a sidewall, said base and sidewall comprising:
vegetable parchment filled with at least 10 kg per metric tonne of titanium dioxide.

6. In combination, a food item resting on a liner, said liner comprises vegetable parchment filled with TiO₂ and coated on a first side with a silicone coating.

7. A cooking container having a base and a sidewall surrounding said base, said sidewall and base formed from a sheet of vegetable parchment, said parchment having an inorganic filler in an amount effective to prevent charring of heat resistant parchment at a temperature of 500° F. for two minutes.

8. The container claimed in claim 7 consisting of vegetable parchment and, optionally, a release coating.

9. A method of cooking a liquid comprising adding said liquid to said container claimed in claim 7 and placing said container in an accelerated cooking oven;
heating said liquid in said oven to a temperature greater than 400° F. for a time of ten seconds to less than two minutes.
